(19) United States
(12) Patent Application Publication
(10) Pub. No.: US 2015/0118587 A1
(43) Pub. Date: Apr. 30, 2015

(54) FUEL CELL STACK INCLUDING DUMMY CELL

(71) Applicant: Hyundai Motor Company, Seoul (KR)

(72) Inventors: Seong Il Heo, Yongin-si (KR); Yoo Chang Yang, Gunpo-si (KR); Chi Seung Lee, Hwaseong-si (KR)

(73) Assignee: Hyundai Motor Company, Seoul (KR)

(21) Appl. No.: 14/285,139

(22) Filed: May 22, 2014

(30) Foreign Application Priority Data
Oct. 28, 2013 (KR) 10-2013-0128427

(51) Int. Cl. H01M 8/04

(52) U.S. Cl. CPC H01M 8/04156
USPC 429/414

(57) ABSTRACT

A fuel cell stack including a dummy cell for effectively discharging condensate water of the stack is provided. At least one cathode/anode dummy cell is stacked between a reaction of a stack power generator and end plates at both ends of the stack to discharge water out of stack. An automation process of the whole stack according to a simplified stack configuration can be achieved.

### CROSS-REFERENCE TO RELATED APPLICATION

This application claims under 35 U.S.C. §119(a) the benefit of priority to Korean Patent Application No. 10-2013-0128427 filed in the Korean Intellectual Property Office on Oct. 28, 2013, the entire contents of which are incorporated herein by reference.

### TECHNICAL FIELD

The present disclosure relates to a fuel cell stack including a dummy cell. More particularly, it relates to a fuel cell stack including a dummy cell for effectively discharging condensate water of the stack.

### BACKGROUND

Generally, a fuel cell is a type of power generation device that converts chemical energy of fuel into electrical energy by performing electrochemical reactions in a fuel cell stack without transforming the chemical energy into heat by combustion. Fuel cells not only provide power for industries, households, and vehicles, but also for small-sized electrical/electronic products, particularly, portable devices.

For example, a polymer electrolyte membrane fuel cell (PEMFC) that is being extensively studied as a power supply source for vehicle driving includes a membrane-electrode assembly (MEA) including an electrolyte membrane through which hydrogen ions move and catalyst electrodes in which an electrochemical reaction occurs attached to both surfaces of the electrolyte membrane. A gas diffusion layer (GDL) evenly distributes reaction gases and transmits generated electrical energy. Gaskets and coupling members maintain airtightness of the reaction gases and cooling water and an appropriate coupling pressure, and a bipolar plate (BP) allows the reaction gases and the cooling water to pass. Here, the BP is divided into an anode plate (AP) in which a flow field is formed to supply hydrogen, and a cathode plate (CP) in which a flow field is formed to supply air including oxygen.

Accordingly, in the fuel cell stack, hydrogen that is fuel and oxygen (air) that is oxidant are supplied to the anode and the cathode of the membrane-electrode assembly through the flow fields of the AP and the CP, respectively. The hydrogen supplied to the anode is decomposed into hydrogen ions and electrodes by catalyst of electrode layers disposed at both sides of the electrolyte membrane. Here, only hydrogen ions selectively pass through the electrolyte membrane that is a cation exchange membrane to be transferred to the cathode, and simultaneously, electrons are transferred to the cathode through the BP and the GDL that are conductors.

Then, at the cathode, the hydrogen ions supplied through the electrolyte membrane and the electrons transferred through the bipolar plate react with oxygen of the air supplied to the cathode to generate water. In this case, due to the movement of hydrogen ions, a flow of electrons through an external conducting wire occurs, generating a current.

In the cycle of the fuel cell stack, at an inlet side of the cathode, condensate water may be introduced through a humidifier, a common distributor, an end plate, a stack (bipolar plate) manifold. At an inlet side of the anode, condensate water may be introduced through a fuel processing system (FPS), the common distributor, the end plate, the stack (bipolar plate) manifold. Also, water passing through the MEA membrane from the cathode may be introduced.

While such water is being introduced into outmost cells contacting an open end plate, the repetition of rapid rise and fall of the cell voltage and the MEA catalyst deterioration due to the presence of a large amount of water may occur.

This phenomenon more severely occurs at an anode circulation loop including a close loop. In case of outmost cells around the close end plate without a manifold hole, when hydrogen or air is supplied through a bipolar plate inlet manifold, water condensed in the manifold disposed in a length direction of the stack is swept to the close end plate to be introduced into the outermost cells. Thus, it is important to remove condensate water except moisture humidifying the MEA inside cells from the inside of the stack in terms of performance stability and durability of a fuel cell vehicle.

In the related-art, water is removed by using driving/controlling technique of a vehicle or installing a water trap, but there is a difficulty in removing water completely.

U.S. Pat. No. 7,163,760 discloses a water drainage structure, in which condensate water, which may be together swept to a stack power generator when hydrogen and air are supplied to the stack power generator, can be discharged out of the stack without being introduced into the stack power generator, by separately including a structure of a bypass plate and an intermediate plate at end cell and end plate parts of a fuel cell stack.

However, in this water drainage structure, the bypass plate and the intermediate plate need to be separately developed and manufactured in addition to the components of the stack, complicating the overall component configuration of the stack.

Korean Patent No. 10-1251254 discloses a water drainage structure, in which one or more cathode dummy cell (CD) and anode dummy cell (AD) are stacked between a reaction cell of a stack power generator and end plates at both ends thereof as a dummy cell for the water drainage of a stack.

However, this water drainage structure is complicate in configuration of dummy cells, and there is a difficulty in stack production automation. Particularly, there is a limitation in that its specifications become very complicated because a total of four types such as an end cathode plate/end anode plate (ECP/EAP), a cathode plate/end anode plate (CP/EAP), an end cathode plate/anode plate (ECP/AP), and cathode plate/anode plate (CP/AP) are needed for a bipolar plate anode/cathode junction.

That is, as shown in FIG. 4, the specifications of the bipolar plate set include the four types of ECP/EAP, CP/EAP, ECP/AP, and CP/AP. Since a GG (GDL/GDL) cannot interrupt reaction gases on the surfaces of the anode and the cathode, a cathode dummy cell (EAP/GG/CP) and an anode dummy cell (AP/GG/ECP) need to be separately manufactured.

The above information disclosed in this Background section is only for enhancement of understanding of the background of the disclosure, and therefore, it may contain information that does not form the prior art that is already known in this country to a person of ordinary skill in the art.

### SUMMARY OF THE DISCLOSURE

The present disclosure provides a fuel cell including a dummy cell, which can achieve automation of the whole stack process according to a simplified stack configuration as well as effectively discharge condensate water of the stack. A dummy cell is disposed between a reaction cell of a stack power generator and end plates at both ends to effectively discharge condensate water, and a metallic plate or a conductive plate is inserted between gas diffusion layers (GDLs) instead of a GG (GDL/GDL) to implement a new water drainage structure to which a dummy layer (D-L) is applied to interrupt mixing of hydrogen/air.

According to an exemplary embodiment of the present disclosure, a fuel cell stack includes a dummy cell, wherein at least one cathode/anode dummy cell is stacked between a reaction cell of a stack power generator and end plates at both ends of the stack to discharge water out of the stack.

The cathode/anode dummy cell may include a combination of an anode plate (AP), a cathode plate (CP), and a dummy layer (D-L) stacked therebetween.

The fuel cell stack may include at least one cathode dummy cell including a combination of an end anode plate (EAP), a cathode plate (CP), and a dummy layer (D-L) stacked therebetween between the end plate at one end and the cathode/anode dummy cell.

The fuel cell stack may include at least one cathode dummy cell including a combination of an end cathode plate (ECP), an anode plate (AP), and a dummy layer (D-L) stacked therebetween between the end plate at one end and the cathode/anode dummy cell.

The D-L may be configured such that a metallic plate or a conductive plate is inserted between gas diffusion layers (GDLs).

An end cathode plate (ECP) or an end anode plate (EAP) may be further stacked on a surface where the dummy cell contacts the end plates at both ends of the stack.

A gas diffusion layer (GDL) may be further stacked between the end plates (EPs) at both ends of the stack and an end cathode plate (ECP) or an end anode plate (EAP).

Other aspects and exemplary embodiments of the disclosure are discussed infra.

### BRIEF DESCRIPTION OF THE DRAWINGS

The above and other features of the present disclosure will now be described in detail with reference to certain exemplary embodiments thereof illustrated by the accompanying drawings which are given hereinbelow by way of illustration only, and thus are not limitative of the present disclosure.

FIG. 1 is a view illustrating a stack structure of a fuel cell stack including a dummy cell according to an embodiment of the present disclosure.

FIG. 2 is plan and cross-sectional views illustrating a dummy layer (D-L) of a fuel cell stack including a dummy cell according to an embodiment of the present disclosure.

FIG. 3 is a schematic view illustrating a comparison between a typical dummy cell structure and a dummy cell structure according to an embodiment of the present disclosure.

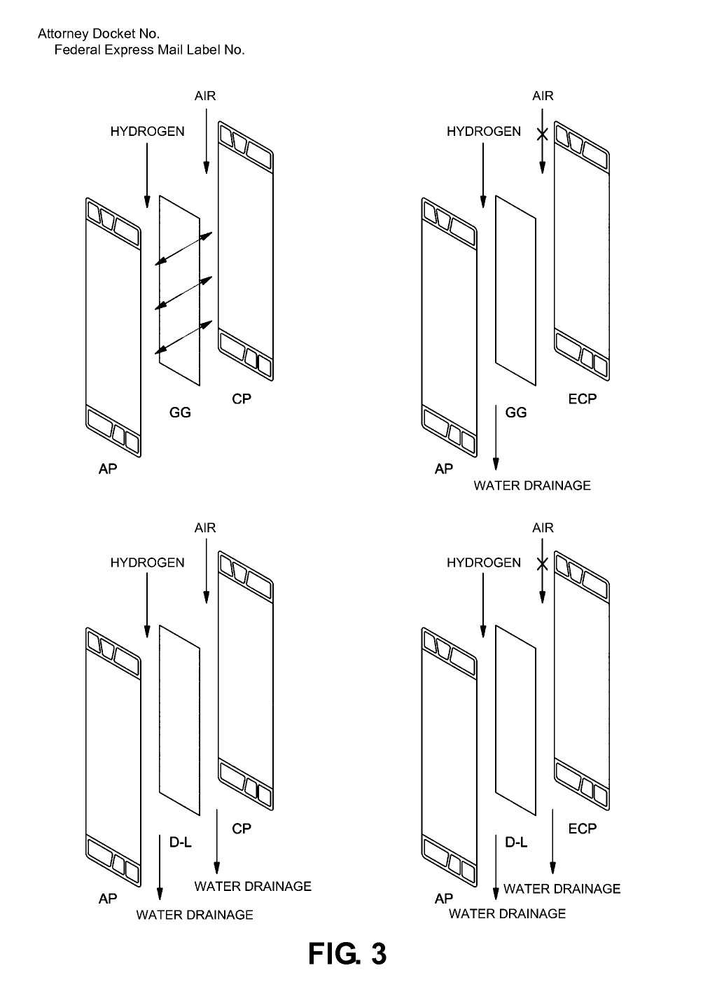

FIG. 4 is a schematic view illustrating a stack structure of a fuel cell stack including a typical dummy cell.

It should be understood that the accompanying drawings are not necessarily to scale, presenting a somewhat simplified representation of various exemplary features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents, and other embodiments, which may be included within the spirit and scope of the disclosure as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats, and ships, aircraft, and the like, and includes hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the disclosure are discussed infra.

Hereinafter, exemplary embodiments of the present disclosure will be described in detail with reference to the accompanying drawings so that those skilled in the art can easily carry out the present disclosure.

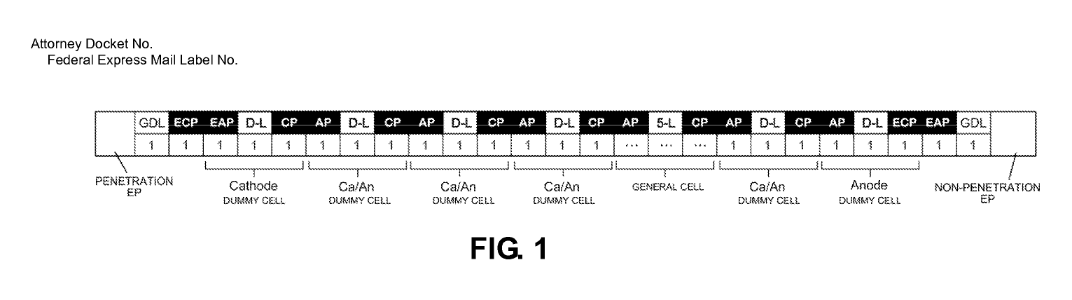

FIG. 1 is a view illustrating a stack structure of a fuel cell stack including a dummy cell according to an embodiment of the present disclosure. As shown in FIG. 1, the fuel cell stack may include dummy cells that are stacked between a reaction cell of a stack power generator and end plates (EPs) at both ends of the stack to effectively discharge condensate water introduced into the stack.

The reaction cell of the stack power generator, which is a general cell structure, may include an anode plate (AP), a gas diffusion layer (GDL), a membrane-electrode assembly (MEA), a gas diffusion layer (GDL), a cathode plate (CP). The dummy cells may include cathode/anode dummy cells including the CP and the AP.

Here, the cathode/anode dummy cell may have a structure in which a dummy layer (D-L) is stacked between the AP and the CP. One or more cathode/anode dummy cells may be stacked between the reaction cell of the stack power generator and the EPs at both ends of the stack, respectively.

Particularly, the D-L may include a metallic plate or a conductive plate inserted between the GDLs instead of a typical GG (GDL/GDL) to form a structure that can interrupt mixing of reaction gases such as hydrogen and air.

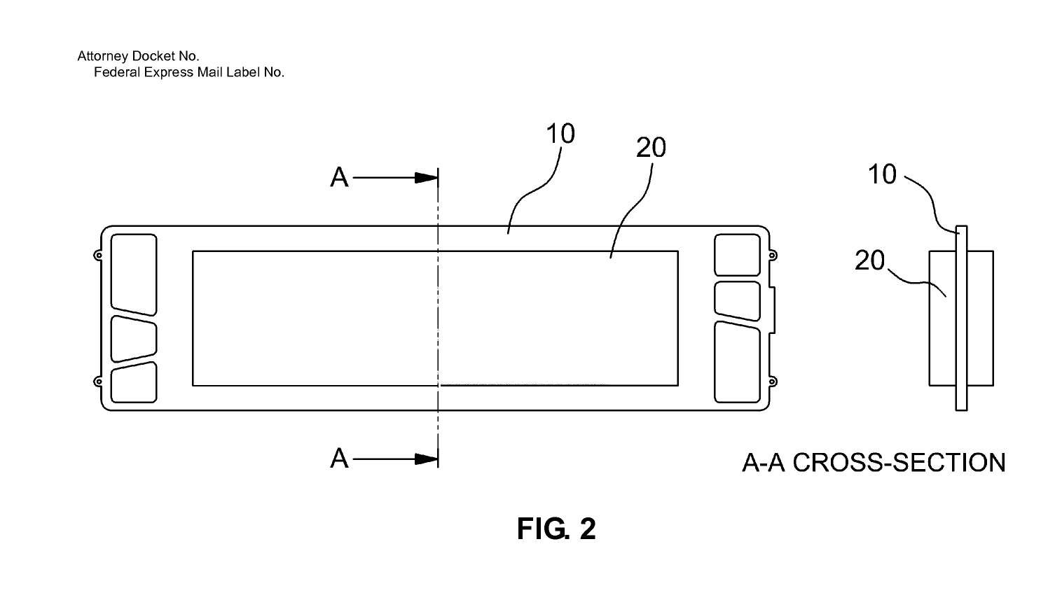

For example, the D-L, as shown in FIG. 2, may include a base material 10 and a support part 20. The base material 10 may have an outline equal to that of a bipolar plate. In this case, the thickness of the base material 10 may not be limited, but may be thinner than the thickness of the bipolar plate. Also, the base material 10 may include a metal (or conductive plate), such as Fe, Ti, and Cu, and if necessary, may include a conductive coating (carbon-based or metal-based). In addition to the above-mentioned materials, any conductive material that does not allow penetration of gases can be applied.

The support part 20 may have the same outline as the GDL. In this case, the support part 20 may be the GDL itself, and may be formed of the same material as the base material 10, such as Fe, Ti, and Cu. In addition to the above-mentioned materials, any conductive material can be applied.

Thus, the effect of discharging water out of the dummy cell under the same dummy cell volume can be improved, by implementing the cathode/anode dummy cells including combinations of the AP, the D-L, and the CP that can interrupt reaction gases on surfaces of the anode and the cathode in one cell.

In an exemplary embodiment of the present disclosure, three cathode/anode dummy cells having the structure in which the D-L is together stacked between the AP and the CP may be provided between a penetration end plate (Open EP) and the reaction cell, and one may be stacked between a non-penetration end plate (Close EP) and the reaction cell. Here, the number of dummy cells may vary with the stack coupling conditions and the operation conditions.

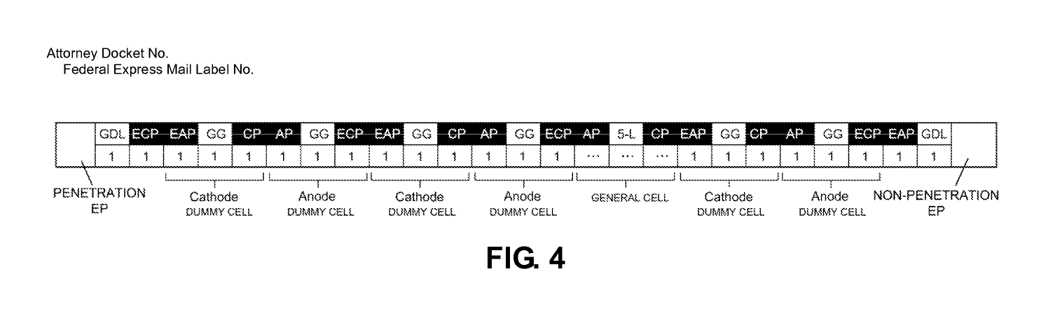

Referring to FIG. 4, the fuel cell stack may include at least one anode dummy cell that is stacked between the end plate at one end, i.e., the non-penetration end plate and the cathode/anode dummy cells.

The anode dummy cell may include a combination of an end cathode plate (ECP), the AP, and the D-L stacked therebetween. In this case, the D-L may also have a structure in which the metallic plate or the conductive plate is inserted between the GDLs to interrupt mixing of reaction gases such as hydrogen and air.

Referring to FIG. 4, the fuel cell stack may include at least one cathode dummy cell that is stacked between the EP at one end, i.e., between the penetration end plate and the cathode/anode dummy cells.

The cathode dummy cell may include a combination of an end anode plate (EAP), the CP, and the D-L stacked therebetween. In this case, the D-L may also have a structure in which the metallic plate or a conductive plate is inserted between the GDLs to interrupt mixing of reaction gases such as hydrogen and air. Also, the cathode dummy cell or the anode dummy cell that is applied between the cathode/anode dummy cell and the end plate may be removed according to the stacking/operation conditions.

Accordingly, as shown in FIG. 4, in case of a dummy cell including a typical AP-GG-CP stack structure, the GG includes only porous GG. Accordingly, when hydrogen and air are simultaneously supplied, the reaction gases may not be interrupted. Thus, like the anode dummy cell (or the cathode dummy cell) including the stack structure of AP-GG-ECP, the anode dummy cell or the cathode dummy cell needs to be separately configured to prevent mixing of the reaction gases.

However, in case of the anode/cathode dummy cell according to an embodiment of the present disclosure, since the D-L can control mixing of the reaction gases by inserting the metallic plate or the conductive plate between the GDLs, the anode/cathode dummy cells can be simultaneously implemented in one cell, and thus, the effect of discharging water out of the stack can be improved.

The EAP and the ECP may be formed by removing hydrogen inlet/outlet holes and air inlet/outlet holes from the typical AP and the cathode plate CP. The EAP according to an embodiment of the present disclosure may include hydrogen manifolds (not shown), cooling water manifolds (not shown), and air manifolds (not shown) at both ends thereof, and may be manufactured in the same shape as the typical AP.

However, the EAP may not include the hydrogen inlet/outlet holes communicating with the hydrogen manifold, and thus, hydrogen gas passing through the hydrogen manifold may not flow into the cell reaction surface of the EAP. Also, the ECP may not include the air inlet/outlet holes communicating with the air manifold, and thus, air passing through the air manifold may not flow into the cell reaction surface of the ECP.

For example, the dummy cell according to an embodiment of the present disclosure, which is stacked to discharge water without a progress of a chemical reaction, may be configured to include the EAP or the ECP. That is, the anode dummy cell for water drainage of the anode may include the AP, the ECP, and the D-L disposed therebetween. The cathode dummy cell for water drainage of the cathode may include the CP, the EAP, and the D-L disposed therebetween.

In the anode dummy cell, hydrogen may be introduced through the AP, but air may not be introduced through the ECP. Accordingly, a fuel cell chemical reaction may not occur, but only the water drainage of the anode may occur. Similarly, in the cathode dummy cell, air may be introduced through the CP, but hydrogen may not be introduced through the EAP. Accordingly, a fuel cell chemical reaction may not occur, but only the water drainage of the cathode may occur.

Accordingly, FIG. 1 illustrates a stack configuration of various dummy cells according to an embodiment of the present disclosure. That is, the cathode/anode dummy cell, the cathode dummy cell, and the anode dummy cell according to an embodiment of the present disclosure may be stacked between the EPs and the reaction cell of the stack power generator in which a plurality of cells are repeated. Here, the reaction cell of the stack power generator, which has a general cell structure, may include a 5-layer MEA in which the GDL, the MEA, and the GDL are joined.

As an example of the present disclosure, the fuel cell stack is exemplified as including the Open EP or the Close EP at both ends of the stack, but may include both Open and Close EPs at both ends of the stack. In addition, the cell configuration shown in the drawings may become sequentially ordered according to the positive (+) and negative (−) directions of the stack module.

FIG. 1 illustrates a configuration of end plate, cathode dummy cell, cathode/anode dummy cell, repeated general cells (reaction cells), cathode/anode dummy cell, anode dummy cell, and non-penetration end plate in order. In this case, the cathode dummy cell and the anode dummy cell that are adjacent to the end plate may be omitted according to the stacking and operation conditions.

In the foregoing embodiment, only air may be introduced into the cathode dummy cell stacked at the side of the penetration end plate, and hydrogen and air may be introduced into the cathode/anode dummy cell.

Accordingly, water introduced through the air manifold of the penetration end plate may be mostly discharged out of the stack through the cathode dummy cell and the cathode/anode dummy cell, and water introduced through the hydrogen manifold of the penetration end plate may be discharged out of the stack through the cathode/anode dummy cell. Also, water condensed in the manifold in the length direction of the stack manifold and flowing to the side of the non-penetration end plate may be discharged through the cathode/anode dummy cell and the anode dummy cell stacked at the side of the non-penetration end plate by the same method.

Accordingly, water introduction into outermost end cells at both ends of the stack power generator, i.e., end cells located at the outermost portion of the reaction cell can be minimized, and water introduced into the stack can be effectively removed.

Thus, the fuel cell stack according to an embodiment of the present disclosure may include various combinations of the cathode/anode dummy cell, the cathode dummy cell, and the anode dummy cell. That is, various combinations and numbers may be implemented as long as at least one of the cathode/anode dummy cell, the cathode dummy cell, and the anode dummy cell is stacked at one or both sides between the end plates and the reaction cell of the stack power generator, respectively.

According to another embodiment of the present disclosure, in case of the dummy cell, an end cathode plate (ECP) or an end anode plate (EAP) may be further stacked on a contact surface with an end plate (EP) at both ends of the stack. That is, the ECP or the EAP may be further stacked on a contact surface at which an end cell of a stack power generator, a cathode/anode dummy cell, a cathode dummy cell, or an anode dummy cell contacts the EPs at both ends.

The outermost ECP and EAP may join with the outermost bipolar plate of the dummy cell or the end cell of the stack generator, which is adjacent thereto, to form a cooling water flow field. Also, since the dummy end plate includes an end cathode plate or an end anode plate, reaction gas/air or cooling water may be allowed not to flow into a current collector at the side of the end plate.

According to another embodiment of the present disclosure, a gas diffusion layer (GDL) may be further stacked between the EP and the ECP or the EAP at both sides of the stack. That is, the GDL may be further stacked between the end cell of the stack power generator or the outermost bipolar plate of the dummy cell and the end plate, or between the dummy end plate and the end plate.

Since the GDL formed of a conductor is inserted, an electrical contact between the outermost bipolar plate (or dummy plate) and the current collector that is inserted into the end plate may be enabled.

Thus, the specifications of the bipolar plate can be simplified into two kinds of CP/AP and ECP/EAP, and thus, the simplification of the stack configuration can be achieved by applying the cathode/anode dummy cell (AP/D-L/CP), the cathode dummy cell, and the anode dummy cell that include the D-L with a structure in which mixing of reaction gases such as hydrogen and air can be controlled by inserting a metallic plate or a conductive plate between the GDLs instead of the GG.

Also, since the AP/D-L/CP can be implemented in one cell, the effect of discharging water out of the dummy cell under the same dummy cell volume can be improved, and the effect of the insulation of the stack power generator and the reduction of the stack volume can be improved.

A fuel cell stack including a dummy cell according to an embodiment of the present disclosure has the following advantages:

First, condensate water of a stack can be effectively discharged and the introduction of water into a cell can be minimized by adopting a combination of a cathode dummy cell and an anode dummy cell as a dummy cell for discharging water out of the stack.

Second, since the AP/D-L/CP can be implemented in one cell, the efficiency of water drainage out of the dummy cell is improved, a stack volume is reduced, and a structure is simplified. Since an automation of the whole stack process can be implemented, a defective rate and the productivity can be improved.

Third, the simplification of a stacking equipment configuration can be implemented due to the simplification of the stack configuration, thus increasing the stack productivity and reducing the cost for the stacking equipment.

Fourth, a dummy cell structure can be disposed between a stack reactor and an end plate to serve as a buffer, thereby improving an insulation effect for outer cells of a stack power generator.

The disclosure has been described in detail with reference to exemplary embodiments thereof. However, it will be appreciated by those skilled in the art that changes may be made in these embodiments without departing from the principles and spirit of the disclosure, the scope of which is defined in the appended claims and their equivalents.

What is claimed is:

1. A fuel cell stack comprising a dummy cell, wherein at least one cathode/anode dummy cell is stacked between a reaction cell of a stack power generator and end plates (EPs) at both ends of the stack to discharge water out of the stack.

2. The fuel cell stack of claim 1, wherein the cathode/anode dummy cell comprises a combination of an anode plate (AP), a cathode plate (CP), and a dummy layer (D-L) stacked therebetween.

3. The fuel cell stack of claim 1, comprising at least one cathode dummy cell comprising a combination of an end anode plate (EAP), a cathode plate (CP), and a dummy layer (D-L) stacked therebetween between an EP at one end and the cathode/anode dummy cell.

4. The fuel cell stack of claim 1, comprising at least one anode dummy cell comprising a combination of an end cathode plate (ECP), an anode plate (AP), and a dummy layer (D-L) stacked therebetween between an EP at one end and the cathode/anode dummy cell.

5. The fuel cell stack of claim 2, wherein the D-L is configured such that a metallic plate or a conductive plate is inserted between gas diffusion layers (GDLs).

6. The fuel cell stack of claim 5, wherein any conductive material can be applied to the GDLs.

7. The fuel cell stack of claim 1, wherein an end cathode plate (ECP) or an end anode plate (EAP) is further stacked on a surface where the dummy cell contacts the EPs at both ends of the stack.

8. The fuel cell stack of claim 1, wherein a gas diffusion layer (GDL) is further stacked between the EPs at both ends of the stack and an end cathode plate (ECP) or an end anode plate (EAP).

9. The fuel cell stack of claim 3, wherein the D-L is configured such that a metallic plate or a conductive plate is inserted between gas diffusion layers (GDLs).

10. The fuel cell stack of claim 4, wherein the D-L is configured such that a metallic plate or a conductive plate is inserted between gas diffusion layers (GDLs).

11. The fuel cell stack of claim 2, wherein an end cathode plate (ECP) or an end anode plate (EAP) is further stacked on a surface where the dummy cell contacts the EPs at both ends of the stack.

12. The fuel cell stack of claim 3, wherein an end cathode plate (ECP) or the EAP is further stacked on a surface where the dummy cell contacts the EPs at both ends of the stack.

13. The fuel cell stack of claim 4, wherein the ECP or an end anode plate (EAP) is further stacked on a surface where the dummy cell contacts the EPs at both ends of the stack.

14. The fuel cell stack of claim 2, wherein a gas diffusion layer (GDL) is further stacked between the EP at the both ends of the stack and an end cathode plate (ECP) or an end anode plate (EAP).

15. The fuel cell stack of claim 3, wherein a gas diffusion layer (GDL) is further stacked between the EPs at the both ends of the stack and an end cathode plate (ECP) or the EAP.

16. The fuel cell stack of claim 4, wherein a gas diffusion layer (GDL) is further stacked between the EPs at the both ends of the stack and the ECP or an end anode plate (EAP).
